(19) United States
(12) Patent Application Publication
(10) Pub. No.: US 2004/0212546 A1
(43) Pub. Date: Oct. 28, 2004

(54) Perception-based management of color in display systems

(76) Inventors: Brian S. Dixon, Albany, OR (US); Peter Guy Howard, Junction City, OR (US); David H. Ochs, Corvallis, OR (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/423,365

(22) Filed: Apr. 23, 2003

(51) Int. Cl. G09G 5/00

(52) U.S. Cl. 345/1.1

(57) ABSTRACT

A method for color management in a display system based on perception. A plurality of images may be displayed to a viewer using an additive display device. Each image of the plurality may have a different color adjustment and at least two colors. An input may be received from the viewer selecting an image of the plurality based on the viewer's color perception of such image relative to other images of the plurality. Subsequent images may be displayed according to the different color adjustment of the image selected.

### BACKGROUND

Image display devices, such as projectors, rely on the additive properties of light to create colors in displayed images. Such devices generally project light of three different wavelengths or wavelength-ranges (red, green, and blue) onto a viewing surface in appropriate proportions to create a gamut of many colors perceived by a person viewing the surface (the viewer). However, ambient light also combines additively with the projected light at the viewer's retina to alter the viewer's color perception of the projected light.

The contribution of ambient light to color perception may be different for each display system, based on a complex interplay of elements. Different combinations and properties of the elements produce different changes in the colors perceived by the viewer. These elements may include properties of the surround, which is defined as every optically active component of a display system other than the displayed image. The surround may include any ambient light source that introduces other light into the display system, surfaces or objects that modify light within the display system (such as light absorption, reflection, diffraction, polarization, scattering, etc.), and so on. Different types of ambient light sources may have very different spectral power distributions, and thus, different effects on the perceived color gamut. In addition, the surround combines with the projector light source, which may have a spectral power distribution that depends on the type of light source. Furthermore, the placement of ambient light sources relative to the viewer and the projector light source, the relative intensities of the ambient and projector light sources, and the color gamut of the projector, among others, may interact to determine how the ambient light alters color perception.

It may be complex and difficult for an average viewer (or even a color scientist) to measure ambient light within a display system and predict which color correction scheme would be best. For example, the viewer may perform a series of trial-and-error corrections to attempt to identify the correction that is best. However, selecting a proper correction may be difficult because problems with perceived colors may not be evident with the colors in test images chosen by the viewer. Accordingly, many additive display systems ignore the contribution of ambient light.

### SUMMARY

A method is provided for color management in a display system based on perception. A plurality of images may be displayed to a viewer using an additive display device. Each image of the plurality may have a different color adjustment and at least two colors. An input may be received from the viewer selecting an image of the plurality based on the viewer's color perception of such image relative to other images of the plurality. Subsequent images may be displayed according to the different color adjustment of the image selected.

### BRIEF DESCRIPTION OF THE DRAWINGS

FIG. 1 is a view of a system for perception-based management of displayed color, in accordance with an embodiment of the invention.

FIG. 2 is a graph of the response of each of the three types of human color photoreceptors as a function of the wavelength of light.

FIG. 3 is a CIE chromaticity diagram showing an unmodified color gamut from a projector and a modified color gamut produced by addition of ambient light.

FIG. 4 is a graph of a spectral power distribution produced by cool-white fluorescent light.

FIG. 5 is a schematic view of the system of FIG. 1.

FIG. 6 is a view of an embodiment of a color-management image displayed in the system of FIG. 1.

FIG. 7 is a composite view of the image of FIG. 6 displayed with different color adjustments in the system of FIG. 1.

FIG. 8 is a flowchart of a method for managing color in a display system based on perception, in accordance with an embodiment of the invention.

### DETAILED DESCRIPTION

A display system, including method and apparatus, is provided for management of color based on perception. In the system, a plurality of images may be displayed to a viewer using an additive display device in ambient light. Each image may be modified from an original form by the ambient light and a different color adjustment. In addition, in the original form and/or modified form, each image may include at least two colors. The colors may define or correspond to colored regions that define a shape. An input may be received from the viewer selecting an image of the plurality based on the viewer's color perception of the image relative to other images of the plurality. The color perception may be a perceived distinctiveness of the at least two colors relative to another, a color preference of the viewer, and/or an ability to discern the shape defined by the colored regions. The color perception may be determined by the effects of the color adjustment and the ambient light on each of the colors. In some embodiments, colors that are intended to be distinctive may be displayed together in each image, and a viewer may determine which of the images has a color adjustment that provides the desired and/or best perceived distinctiveness of the at least two colors in the ambient light. This color adjustment then may be applied to subsequent images in the ambient light, so that a color correction suited for the particular viewing condition and viewer is implemented. The color adjustment may be digital, analog, and/or optical. In some embodiments, the at least two colors may have different hues and may belong to different color families. In addition, the at least two colors may be selected so that they are relatively sensitive to the effects of ambient light. For example, the colors may have hues disposed between red and green, such as orange-pink and greenish-yellow, and/or may have high lightness.

The system described herein may have substantial advantages over systems not based on perception. For example, the system allows a viewer to provide a color correction suited to a particular viewing condition with no a priori knowledge about color science, lighting technology, or other issues relating to the interrelationship of the viewing environment and color perception. In addition, the system may rely on colors that are most likely to be displayed incorrectly in ambient light. Furthermore, the color correction may be better than any achieved with optical sensing instruments, because a viewer selects the best correction for him/herself. This approach may greatly simplify color correction for the viewer.

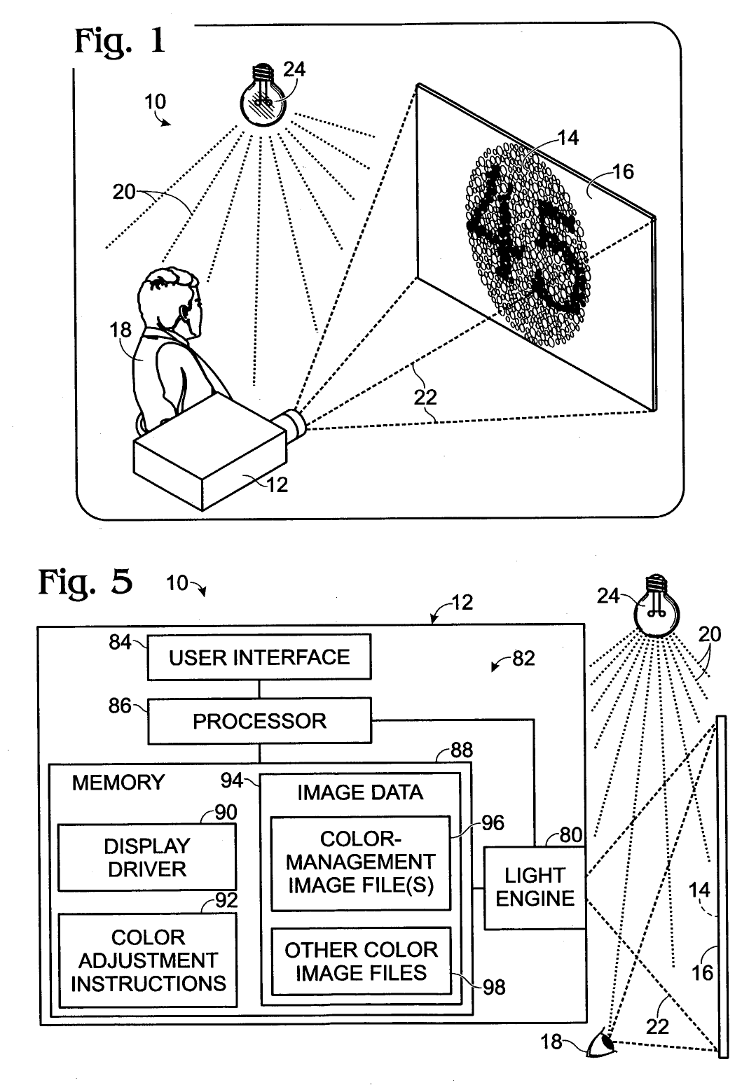

FIG. 1 shows a display system 10 for perception-based management of displayed color. System 10 may include a display device 12 that displays a plurality of images, such as a color-management image 14 for selecting a color correction, on a surface 16. System 10 also may include a person or viewer 18 positioned to view image 14, in order to perceive image colors in ambient light 20.

Display device 12 may include any optical device configured to display visible images based on digital and/or analog representations of the images. The display device preferably displays color images that are created by additively combining light of different wavelengths in a spatial pattern for the viewer. Exemplary additive display devices include projectors, monitors, and/or televisions, among others. Projectors may project light to viewing surface 16, which reflects the light to the viewer. Monitors and non-projection televisions, for example, may transmit light from suitable color emitters, such as phosphors, to the eyes of a viewer, generally without substantial reflection. In some embodiments, the display device may be a subtractive display device, such as a printer, which creates subtractive images that remove light according to the absorptive properties of dyes positioned on print media.

Displayed images may have any suitable spatial arrangement of colored light presented to a viewer. The displayed images may be from a set of color-management images 14 or from a set of subsequent images.

Each color-management image 14 is an image with a different color adjustment. Accordingly, such images may be presented to a viewer so that the viewer can select one or more of the images based on color perception of the one or more images. As used herein, color perception is any physiological sensing of color by the visual system of a human viewer and any psychological processing that occurs during and/or after sensing. Exemplary color perception may include identifying colors by name, comparing colors to predefined color names, and/or comparing two or more colors to each other within an image for similarity or contrast. Psychological aspects of color perception may include a bias or preference of the viewer in relation to sensed colors to select a preferred color rendition and thus color adjustment. The preferred color rendition may be selected, for example, based on an emotion or feeling associated with sensing a color or colors, and/or the perceived desirability of a particular color or color combination. The bias or preference may be a learned bias or preference, a cultural or regional bias or preference, and/or a bias or preference based on the particular physiology of the viewer. In some embodiments, color perception may include perceived distinctiveness of two or more colors relative to one another within an image, for example, based on internal contrast within the image. Accordingly, a plurality of color-management images may be displayed to viewer, so that the viewer can choose one (or more) of the images with the desired appearance, best perceived distinctiveness, best discernibility of a shape defined by the image, etc. Color-management images are described further below.

The color adjustment associated with the selected color-management image(s) then may be applied to display of subsequent images so that these subsequent images have improved or “corrected” displayed colors. Any subsequent images may be suitable including, but not limited to, images that are displayed as recognizable discrete units to provide a slide show (photographs, graphics, drawings, and/or the like), or in rapid succession as a video (such as a motion picture, a home movie, a television show, an animated cartoon, etc.), among others. Such images may be created from digital files and/or analog storage media (such as tape or film), among others.

Surface 16 is any viewing site from which displayed light 22 produced by the display device is directed to a viewer's eyes. Exemplary viewing surfaces may include a reflective surface, a screen, a wall, an array of light-emitting diodes or phosphors, and/or the like.

Viewer 18 may include any person that can see the images. Viewer 18 may be one person or a group of people. When viewer 18 is a group, the group may select from among the color-management images by consensus or by any other suitable selection method.

Ambient light 20 may be any light other than displayed light 22 from display device 12. The ambient light is a result of a viewing condition. Accordingly, the ambient light may result from additional light sources 24 (such as room lights, sunlight, etc.) and/or stray light from the display device. In addition, the ambient light may be affected by how additional light sources and/or stray light interacts with objects or surfaces in display system 10. Further aspects of ambient light are described in the Background section.

Creation (display) of color-management images 14 may be based on known aspects of color perception by the human visual system (HVS). Such known aspects may be important in identifying colors that are more likely to be sensitive to the effects of ambient light. Accordingly, further description of system 10 is deferred until after the following description of color perception.

An individual color perceived by the HVS depends on the spectral content of light entering the eye. This spectral content is measured by three types of cones or color photoreceptors in the retina: long-, medium-, and short-wavelength cones, abbreviated as L, M, and S, respectively. The individual responses of these cones to light is integrated by the HVS into a single perceived color. Accordingly, additive combinations of different wavelengths of light may be perceived as though a single monochromatic source were being observed, albeit with a difference in perceived saturation or purity. For example, an appropriate combination of red and green light is perceived as equivalent in hue to monochromatic yellow light, because each produces a comparable stimulation of the three types of cones, resulting in a similar spectral color. Nonspectral colors, such as magenta, may be produced as a combination of red and blue light, but generally not by a monochromatic light source.

Most perceived colors result from a range of spectral energies, rather than monochromatic light. Changing the spectral content of light produces a corresponding change in the relative responses of the three types of cones, resulting in a different perceived color. For example, selectively removing particular wavelengths of light by filtering may alter the relative responses of the three cones to the light and may produce a different perceived color.

FIG. 2 shows a graph 30 of the response of the three types of color photoreceptors as a function of the wavelength of light. S cones respond maximally to light of about 440 nm, shown at 32, M cones to light of about 540 nm, shown at 34, and L cones to light of about 610 nm, shown at 36. These responses show considerable overlap. S and M cones provide an overlapped response in a region from about 450 nm to 530 nm, with maximal overlap at about 492 nm, shown at 38. M and L cones show a much more substantial overlapped response in a region from about 540 nm to 615 nm, with a maximum overlap at about 584 nm, shown at 40.

Colors that fall within regions of overlapped cone response are differentiable by the HVS because cones that are adjacent in graph 30 resolve different colors from the perceived range of spectral energies. However, the ability to perceive different colors may be dependent upon the separation between maximal cone responses. With a greater separation and less overlap, the perceivable gamut of colors may be larger and two light spectra that are less distinct in spectral content still may be perceived as distinct colors to the viewer. Similarly, less separation and more overlap in the response may make colors that fall within regions of overlap more difficult to distinguish. For example, if a viewer has an abnormal HVS, in which the responses of green and red cones overlap more than normal, then some colors within the area of overlapped response may be difficult to distinguish. Such an abnormal HVS perceives a different, smaller gamut of colors than a normal HVS. In addition, many of the colors that are perceived as distinct by a normal HVS are combined or quantized in the abnormal HVS, so that these colors appear similar to the observer. Accordingly, some colors may change “name boundaries” in the abnormal HVS, for example, some reds and greens may be confused.

Ambient light may affect color perception in a display system in ways similar to a decreased separation of cone responses. The ambient light reduces and/or imbalances the gamut of colors perceived by the viewer in the system. Displayed colors are compressed into a reduced gamut, so that colors intended to be distinct are perceived as similar. Differentiating these colors in such a system becomes difficult. Such changes in perceived colors in response to the viewing condition are termed flare. Colors that are nearer white, that is, high lightness colors, are more prone to flare, because their perception is more sensitive to any change in the white point of the display system produced by ambient light. Furthermore, flare tends to be more pronounced in additive color display systems relative to subtractive systems, such as printers. Flare also may have more impact on reflective display systems, such as projectors, than on transmissive display systems, such as monitors.

The effect of flare in a display system may be exemplified using a graphical representation of perceived color, termed a CIE chromaticity diagram. The CIE chromaticity diagram is a two-dimensional Cartesian plot showing the subjective relationship among colors perceived by an average HVS when additively stimulated by different combinations of three mathematically defined primary colors, or tristimulus values (X, Y, Z). The tristimulus values X, Y, Z generally correspond to theoretical versions of the primary colors red, green, and blue, respectively. These theoretical versions, in contrast to actual red, green, and blue light, define a completely additive color space.

In the CIE chromaticity diagram, perceived colors are plotted as a function of the normalized relative intensities of the tristimulus values. A normalized relative intensity “x” of the tristimulus value X is plotted against the normalized relative intensity “y” of the tristimulus value Y. The normalized relative intensity “z” of the tristimulus value Z at any point on the graph may be obtained by adding x and y, and subtracting the total from one. The full gamut of colors perceived by the HVS falls within a sail-shaped area on the diagram. Colors around the perimeter of the area have different hues. Colors along the upper, arced portion of the perimeter, from blue to green to red, correspond to the spectrum of visible colors. Colors along the generally horizontal, base portion of the perimeter are nonspectral colors, such as magenta, produced by combining blue and red. The perimeter defines fully saturated colors and any path from a position on the perimeter, to the white point or achromatic position at the center, defines decreasing saturation of the color from the perimeter position.

FIG. 3 is a CIE chromaticity diagram 50 showing an unmodified and a modified color gamut from a projector. In this example, the projector uses a metal halide lamp to provide red, green, and blue light, which are perceived at red, green, and blue chromaticity points 52, 54, 56, respectively. The original color gamut that can be produced by the projector using combinations of red, green, and blue light (RGB light) is defined within a triangle 58 having chromaticity points 52, 54, 56 at its corners. Any color within the triangle or original gamut 58 may be produced by a suitable combination of the red, green, and blue light from the projector. The center of gamut 58 is the white point 60 of the projector, which describes the color produced by combining all of the red, green, and blue light from the projector. In this example, white point 60 is influenced more greatly by green and blue light than red light, so the white point is blue-green having a chromaticity point of (0.30, 0.30), whereas achromatic light has a chromaticity point of (0.33, 033).

The white point may be produced by the RGB light from the display device or from RGB and white light from the display device. In other words, with a “clear” filter in the device, the naked light from the lamp of the display device may be projected directly onto the viewing surface, only filtered by optical system losses. Accordingly, the white point of the display using the naked light and the clear filter may be different than the white point produced by R+G+B alone, and the two white points together may produce a third white point that is somewhere between the other two white points. In general, a color adjustment/correction may be selected around the lamp white point by itself, the R+G+B white point by itself, or by a combination of the two. Schemes exist for combining the RGB and white light to produce a broader range of brightness for the display device and color errors and adjustments may be different depending on what combination of filters are being used when the viewer selects a color adjustment.

In other examples, a display device may additively combine any suitable number of colors, and thus is not limited to three primary colors. For example, a display device may additively combine red, green, blue, cyan, magenta (band rejection in middle frequencies), yellow, and white light. Additive combination of greater than three colors may provide an advantage, for example, by extending the display gamut outside of the triangle defined by RGB light only.

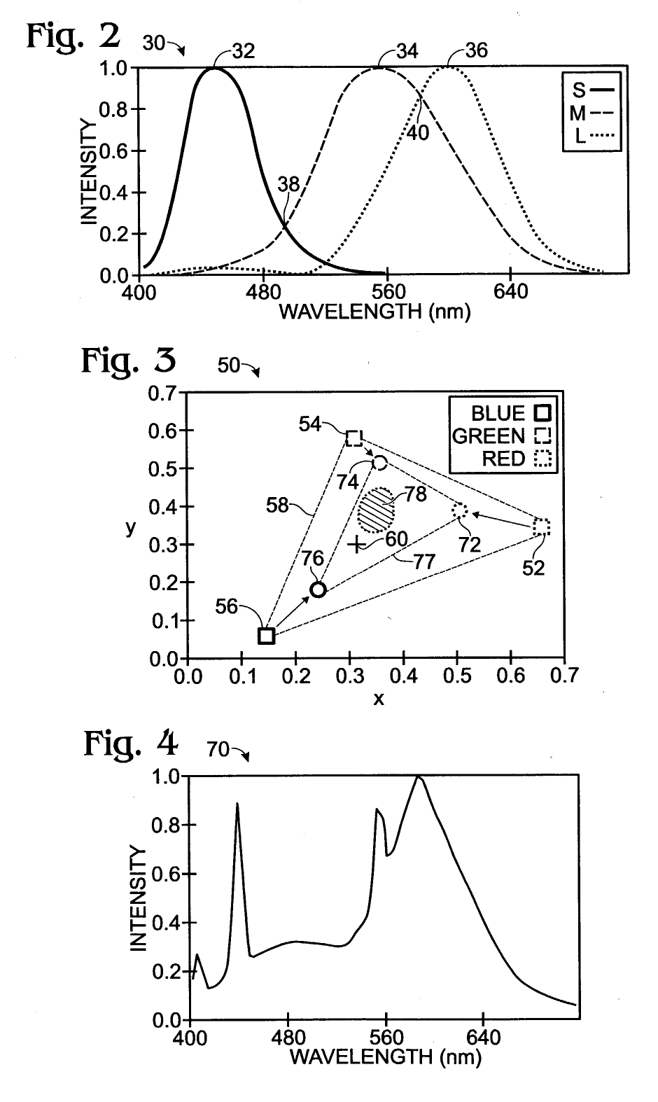

FIG. 4 is a spectral power distribution 70 from a cool-white fluorescent light. This type of light is an example of an ambient light source that may alter the color gamut produced by the projector, although ambient light sources differ substantially in their spectral power distributions. In the present example, the intensity of spectral power distribution 70 varies according to wavelength, with at least three substantial peaks of increased intensity. When summed, power distribution 70 provides a white point that is distinct from the blue-green white point of the projector.

FIG. 3 shows an exemplary modification of color gamut 58 by additive combination with ambient light of power distribution 70. The original chromaticity points 52, 54, 56 at the corners of gamut 58 are shifted centrally to points 72, 74, 76, respectively, when the projector light is modified by fluorescent ambient light. The resultant modified color gamut 77, defined by a smaller triangle with corners 72, 74, 76, is compressed, occupying an interior portion of original gamut 58. Accordingly, a viewer perceives a smaller range of colors. In addition, the ambient light produces a larger shift in the original red chromaticity point 52, than on the green chromaticity point 54, as shown by arrows of unequal length extending to new points 72, 74, respectively. This unequal shift moves white point 60 to a new position in the chromaticity diagram (not shown). Consequently, displayed colors of high lightness, positioned near white point 60, such as colors in a confusion region 78 between red and green, move toward the new white point to produce flare. Some of these displayed colors may shift into nearby areas of the chromaticity diagram that have a different color name by moving a relatively short distance within confusion region 78. The confusion region may be any region of a color space having two or more colors that belong to different color families disposed near one another, such as pink and light yellow. Therefore, color-management images 14 of system 10 may include colors that are particularly sensitive to the effects of ambient light, such as at least two colors from a confusion region.

FIG. 5 shows a schematic view of system 10. Display device 12 of system 10 may include, but is not limited to, a light engine 80 and a controller 82 configured to control operation of the light engine. Display device 12, particularly controller 82, also may include interface circuitry (not shown), for example, signal conversion devices (such as digital-to-analog conversion, analog-to-digital conversion, YPbPr to RGB, etc) that may be utilized for color adjustment/correction.

Light engine 80 may create displayed images from corresponding digital image files (or analog storage media). Creating or displaying may include any digital, analog, and/or optical operation that converts a stored image representation to an image that is visible to the viewer. The light engine may include a light source and optics. Any suitable light source or set of sources may be used, including an incandescent lamp(s), a high-intensity discharge lamp(s), a light-emitting diode(s), fluorescent materials, phosphorescent materials, and/or the like. Exemplary light sources may include a metal halide lamp or a tungsten lamp. The optics generally include any optical mechanisms configured to modify light from the light source to produce displayed images. The optical mechanisms may act by reflection, refraction, diffraction, polarization, filtering, and/or scattering, among others. Accordingly, the optical mechanisms may include lenses, mirrors, filters, gratings, prisms, liquid crystal displays (LCDs), etc. In exemplary embodiments, the optical mechanisms receive a broad spectral distribution of light from the light source, and resolve the light with a prism and mirrors, or with a revolving filter wheel, into different light components These light components may correspond generally to colored light that is red, green, and blue (or may have any other suitable number of additive color components). With three primary color components, for example, displayed images may be created by transmitting the light through LCDs, forming red, green, or blue portions of images to be displayed. Alternatively, displayed images may be produced by sending each of the lights to a processor-controlled micro-mirror array.

The display device may display different color portions of each image sequentially or in parallel to create the image. With sequential display, the different color portions may be combined additively within the HVS of the viewer. With parallel display, different colored portions of an image may be projected to the viewing surface at the same time. This may be performed, for example, with a plurality of display elements, each projecting an image aligned to illuminate the same region of the viewing surface, for example, as in a theater. Alternatively, a plurality of color-separated images may be combined onto a single display element (LCD, micro-mirror, etc.) at the same time.

Controller 82 may be any mechanism or set of mechanisms that determines the content of images displayed by light engine 80. Accordingly, the controller may receive, manipulate, and store digital and/or analog image data and other data relating to manipulation of the image data, for example, for color adjustment.

Controller 82 may include, but is not limited to, a user interface 84, a processor 86, and memory 88. These and other mechanisms of the controller may be included in a single apparatus or may be distributed between two or more coupled apparatus. User interface 84 may be any mechanism for receiving inputs from viewer 18. The user interface may include a keyboard, a mouse, a keypad, a touch screen, etc. The user interface may be used, for example, to start/stop display of images, and particularly, to indicate to the controller which color-management image(s) is selected by the viewer. Alternatively, or in addition, the user interface may be employed as a part of a setup procedure, for example, to tune the gain and/or offset of A/D converters. Processor 86 may be any device capable of receiving data from the user interface and the memory and of performing digital manipulation of such data, such as arithmetic and logic operations, among others, to create instructions for use by the light engine to display images.

Memory 88 may be virtually any mechanism for storing data, including, but not limited to ROM (such as EEPROM or flash memory), RAM, film, tape, and/or other magnetic, electronic, and/or optical storage device(s) or media. The memory may include, but is not limited to, a display driver 90, color adjustment instructions 92, and image data 94.

Display driver 90 generally includes any hardware or software configured to convert image data 94 into display data that controls and/or is used by light engine 80 to create corresponding displayed images. Accordingly, the display driver may translate image data from a device-independent color space to the color values of the display device. Alternatively, or in addition, the display driver may convert color values into images displayed on LCDs or into instructions that control or are recognized by a micro-mirror array, among others.

Color adjustment instructions 92 may be any instructions that modify the display of images from digital image files or analog representations by including (or applying) a color adjustment in (to) the images. The color adjustment may be any alteration of one or more colors within an image, produced during creation of the image. The alteration may be perceived easily by the viewer, or may be relatively imperceptible. The color adjustment may change the hue, lightness, and/or saturation of one or more of the image colors relative to an absence of the color adjustment. Accordingly, different color adjustments may produce different changes to the hue, lightness, and/or saturation of one or more colors of the displayed images. Color adjustments may alter the perceived distinctiveness of one or more colors (or colored regions) relative to one another within the images.

The color adjustment instructions may be digital instructions for digital modification of digital image files that define how the images are created, analog instructions for analog modification of analog signals, and/or optical instructions for optical modification of the images as they are created by the light engine. In some embodiments, the color adjustment instructions and thus color adjustments may be provided by a manufacturer of display device 12.

Digital and/or analog instructions may produce color adjustment of image data before and/or during implementation of the data by light engine 80 to display corresponding color-adjusted images. Adjustments may be performed mathematically, for example, with analog electronics or using look-up tables. Digital instructions may include, for example, hardware-, firmware-, or software-implemented look-up tables that re-map input color values of image files to output color values that are used to create the corresponding color-adjusted images. In some embodiments, the look-up tables may provide transformations that map input red/green/blue values to adjusted output red/green/blue values for each pixel in a color-adjusted image. Accordingly, the look-up tables may change each of the component color values of an image pixel, or a subset thereof. Whether expressed in analog or digitally, output color values-that combine to create a displayed color may be modified as a function of individual or multiple input values. For example red output may be a function of red input only, red output may be a function of red, green, and blue input, or other types of transformations may be used. The function used may be expressed in analog and/or digital space. Suitable look-up tables may be provided by a manufacturer of the display device, may be developed by an operator of the display device, may be provided by other sources, and/or the like. Changes defined by the look-up tables may be applied to digital image files by the color adjustment instructions at any suitable time before and/or during creation of a displayed, color-adjusted image from the image file. Alternatively, or in addition, digital (or analog) instructions may include digital (or analog) re-adjustment of the displayed white point by providing global remapping (linear or nonlinear scaling) of one or more of the component color values that define each pixel. For example, if red values in the images can have values from 0-255 before white-point adjustment, each of these values may be mapped by the white-point adjustment to another range, such as 0-242, 0-230, etc. In this exemplary adjustment, the white point is shifted toward blue and green.

Digital instructions may correspond to different preconfigured digital display profiles, such as International Color Consortium (ICC) profiles. Accordingly, the viewer may select from among images to which such different preconfigured profiles have been applied. A preconfigured profile that is selected then may be associated with the display device, thereby providing calibration of the display device. Exemplary preconfigured profiles may include coordinates for red, green, blue, and the white point, may define the gamma, and/or may define additional display parameters. In some embodiments, the preconfigured profile may include look-up tables and/or 3×3 matrices that are defined for remapping colors and performing white point shifts.

Optical instructions may produce color adjustment of displayed images through modification of light engine 80. Accordingly, the optical instructions may modify any suitable aspect(s) of the light source(s) and/or optics.

Aspects of the light source that may be modified include intensity of the source, type of light source, spectral power distribution of the light source, and/or the like. The intensity may be modified, for example, by increasing power to the light source to increase the intensity and thus lessen the impact of ambient light. The type of light source may be modified, for example, by selecting a different light source for use in the light engine or by selecting a different combination of light sources that function in the light engine. The spectral power distribution may be modified, for example, by altering composition of a gas, a fluorophore, etc. included in the light source.

Aspects of the optics that may be modified include the number, type, or efficiency of optical mechanisms in the light engine. Exemplary optical modifications may alter the spectral power distribution of light from the light source, in a wavelength-selective fashion, for example, by using a band-rejection filter. Such wavelength-selective filtering may be implemented at any time before and/or as the light is displayed, for example, before, during, and/or after resolving the light into color components. In exemplary embodiments, a filter may be used that removes light selectively from one or two of the color components of light. For example, in a particular exemplary embodiment in which images are formed from three color components, a blue light component may have a spectral distribution of about 380-510 nm, a green component about 465-585 nm, and a red component about 575-700 nm. A band rejection filter may be introduced that rejects light having wavelengths of about 570-590 nm. Accordingly, in this example, the red and green components are defined by narrower ranges of wavelengths, and the displayed gamut increases towards the original gamut (before combination with ambient light), or beyond the original gamut. In other embodiments, such a filter may be configured to remove light from any portion of the spectral distribution of one of the light components, particularly a portion of one or both of the overlapped cone-response regions, as defined above in relation to FIG. 2. A plurality of filters may be used individually or in combination to apply a set of different color adjustments to an image as it is created. In some cases, the filters may be configured to correct particular conditions of flare or ambient light (for example, based on a type and/or technology of lamp).

A color adjustment that modifies the optics of the light engine may be combined with a digital and/or analog adjustment. For example, altering the spectral distribution of light, such as with a band-rejection filter, as described above, may alter the white point of the system. Accordingly, any suitable digital and/or analog adjustment may be combined with an optical adjustment, such as adjusting the white point provided by the light engine.

Image data 94 generally includes digital or analog representations of any images to be displayed by the display devices. For example, the digital representations may be raster files that specify color values for each pixel or element within an array of such pixels or elements. In exemplary embodiments, each pixel may have three color values associated with the pixel, corresponding to the level of red, green, and blue to be displayed by light engine 86. However, any other digital or analog representation may be suitable.

Image data 94 may include one or more color-management image files (or representations) 96 and one or more other color image files (or representations) 98. The color-management files may be one file or representation to which different digital, analog, and/or optical color adjustments are applied from the color adjustment instructions. Alternatively, the color-management files or representations may be a set of different files or representations, as described further below in relation to FIG. 7. Additional image files 98 may be any other image files or image representations that are used to create/display subsequent images having the color adjustment selected by a viewer.

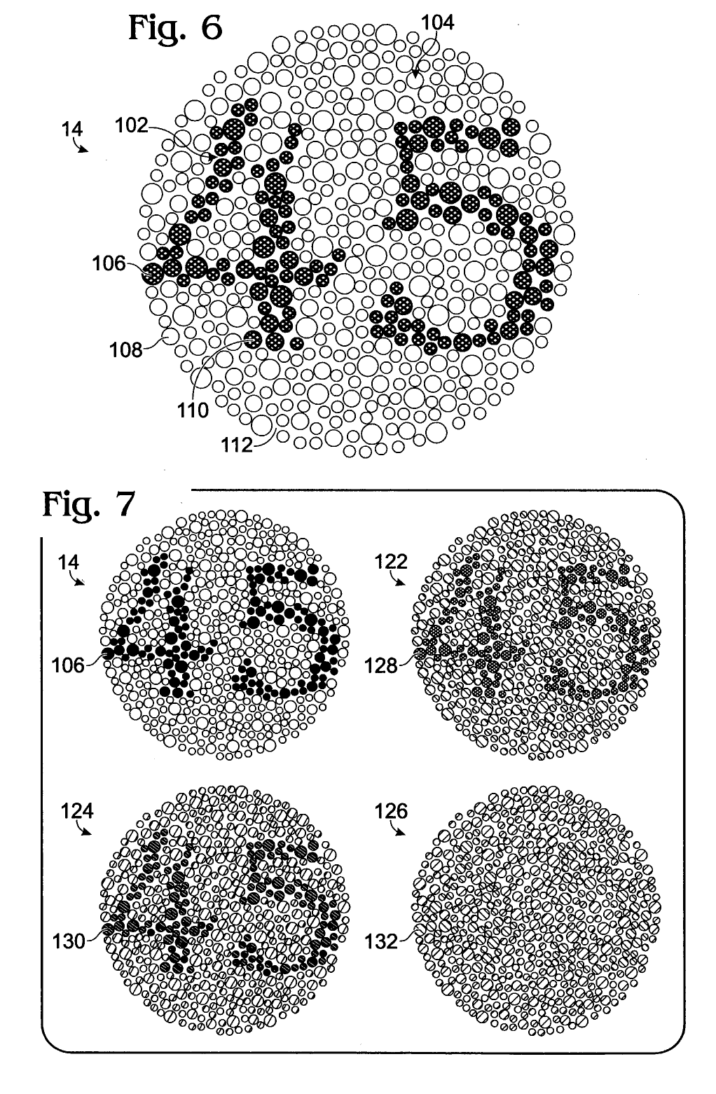

FIG. 6 shows an embodiment of color-management image 14 that may be displayed in system 10. Image 14 may include at least two colors that define or correspond to at least two colored regions 102, 104. In some embodiments, each colored region may form a foreground or a background. For example, here region 102 is the foreground and region 104 the background. The colored regions may cooperatively define a perceived shape or shapes 106, or may define or form part of a picture, among others. In FIG. 6, the colored regions define the numerical symbol “45.” In other embodiments, shape 106 and/or image 14 may correspond to or define any suitable symbol, pattern, design, object, photograph, drawing, or the like, such as a letter, a number, a word, a picture, a diagram, a rectangle, adjacent rectangles, alternating stripes or concentric rings, or the like.

Colored regions 102, 104 may be said to cooperatively define shape 106 because the ability of a person to discern the shape may depend upon a perceived contrast between the colored regions (or colors that define the regions). The contrast may be provided by a perceived difference in hue, saturation, and/or lightness of the colored regions. In some embodiments, each of colored regions 102, 104 may have a different perceived hue. Accordingly, image 14 may be similar to an Ishihara diagram used to assess color blindness. The hues may be different enough that each of colored regions 102, 104 has a color belonging to a different color family.

Each color may be perceived as different or as belonging to a different color family before a color adjustment is applied to the image (its original form), after a color adjustment is applied (the displayed image as would be perceived without the effect of ambient light), and/or after the color adjustment and modification by ambient light (modified form). Exemplary different color families are named differently by an average viewer, and may include (between red and green) pink, reddish-orange, orange-pink, orange, yellowish-orange, yellow, greenish-yellow, yellow, greenish-yellow, yellow-green, and yellowish-green; (between green and blue) bluish-green, blue-green, and greenish-blue; (between blue and red) purplish-blue, bluish-purple, purple, reddish-purple, purplish-pink, red-purple, and purplish-red. In some embodiments, the colors of each image belong to at least two of the different color families between red and green, to at least two different color families between green and blue, or to at least two different color families between blue and red. The different color families may be adjacent one another, or separated by at least one color family or by at least two families, among others. Alternatively, or in addition, each of the at least two colors or colored regions of an image may have a high lightness, that is, at least about 50% of the total light of the region is white light. In some embodiments, the colors of each image may be a pair of colors corresponding to an orange-pink and a yellow-green. The orange-pink may be centered approximately at a chromaticity coordinate of about (0.49, 0.38) and within a radius of about 0.15, and the yellow-green may be centered around (0.38, 0.42) and within a radius of about 0.15.

Image 14 also may include one or more additional colored regions of different color. The additional colored regions may be interspersed with sub-regions of colored region 104 and/or 106 (see below), or may be adjacent one or both of the colored regions. The additional colored regions may be configured to diminish or increase the perceived contrast between colored regions 102, 104. Alternatively, or in addition, the additional colored regions may be configured to form part of shape 106, so that the overall shape is perceived differently when colored regions 102, 104 are distinctive. For example, an additional colored region may form a “−” that is perceived as a “+” in conjunction with a vertically disposed colored region 102 that defines the vertical portion of the plus sign. In other exemplary embodiments with additional colored regions, distinctiveness between colored regions 102 and 104 may convert a frowning face into a smiling face, a “4” into a “9,” and so on. Accordingly, shape 106 defined by colored regions 102, 104 may be only a portion of a symbol, a pattern, a picture, or a larger shape.

The colored regions may be composed of discrete smaller regions, such as sub-regions 108, 110. These sub-regions may have any suitable shape, such as circles, ovals, polygons, irregular shapes (such as pebbles), and/or the like. The smaller regions or sub-regions may be spaced, as shown in FIG. 6, to dispose the sub-regions in a matrix 112. The matrix may have any suitable color including substantially white or substantially black. Alternatively, or in addition, the sub-regions may be spaced by other sub-regions, defined, for example, by an additional colored region.

FIG. 7 shows a composite view of color-management images 14, 122, 124, 126 having different color adjustments in display system 10. Each image may include a corresponding or identical shape 106, 128, 130, and 132, represented in the present embodiment by the number “45.” Here, the color adjustment included in image 14 makes shape 106 appear more distinctive than corresponding shapes 128, 130, or 132 of differently adjusted images 122, 124, 126, respectively. Accordingly, a viewer perceiving these images may select image 14 as most distinctive or as a preferred image. The color adjustment of image 14 then may be applied to creation of subsequent images so that the subsequent images are displayed having such color adjustment. Alternatively, the viewer may select a different image, such as image 124, as the preferred image, for example, because of a preferred white point adjustment, preferred color rendition, etc. As an example, Europeans may prefer a cooler (more bluish) white point and Asians a warmer (more yellowish) white point.

Each different color of the color-management images may be the same in all color-management images before color adjustment. Accordingly, displayed color-management images 14 and 122-126 may be color-adjusted siblings of a parent image. One of the images may correspond to the parent image without any color adjustment. Each sibling may have a different color adjustment applied to the entire image or to at least one of the colors of colored regions 102, 104. The images may be displayed together on a viewing surface, that is, in parallel, and/or may be displayed sequentially.

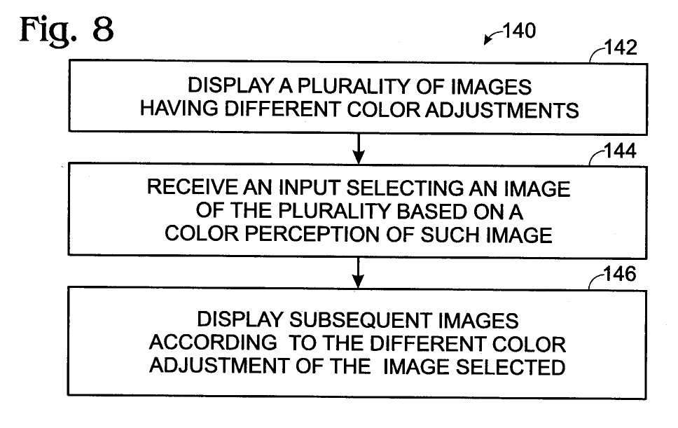

FIG. 8 shows a flowchart of a method 140 for managing color in display system 10 based on perception. The method may be used, for example, to select a color adjustment that improves color rendition in a particular display environment, due to the effect of ambient light in that environment.

In method 140, a plurality of images having different color adjustments may be displayed, as shown at 142. The images may be displayed to a viewer using an additive display device, such as a projector. Displaying images generally includes any suitable aspects of creating the images from a digital/analog representation of such images, including digital, analog, and/or optical implementation or modification, as described above. The images may include at least two different colors that define or correspond to different colored regions. The different colored regions may define a shape. In some embodiments, the two or more different colored regions each may include a color from a different color family, such as a color family between red and green, and may be of high lightness.

An input may be received selecting an image of the plurality, as shown at 144. The image may be selected based on a color perception of such image by the viewer. The image may be selected from among the plurality of images, based on color perception of the selected image relative to the other images. The color perception of each image may be defined by a combination of the ambient light and the corresponding color adjustment of the image. The input may be provided, for example, through a user interface, such as a mouse or keyboard, among others. In some embodiments, the color perception is a perceived distinctiveness of each image when displayed. The image for which perceived distinctiveness is best may be selected. Furthermore, the perceived distinctiveness of each image may be defined according to internal contrast between the two or more different colors or different colored regions of the images. In some embodiments, an ability to discern a shape defined by the colored region may correspond to the perceived distinctiveness.

Subsequent images then may be displayed according to the color adjustment of the image that was selected, as shown at 146. Displaying the subsequent images may include applying the color adjustment of the selected image by digital, analog, and/or optical modification of the subsequent images before and/or during their creation by the light engine. Accordingly, displaying the subsequent images may include modifying display of the subsequent images with the color adjustment

It is believed that the disclosure set forth above encompasses multiple distinct embodiments of the invention. While each of these embodiments has been disclosed in specific form, the specific embodiments thereof as disclosed and illustrated herein are not to be considered in a limiting sense as numerous variations are possible. The subject matter of this disclosure thus includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

What is claimed is:

1. A method of color management in a display system based on perception, comprising:
displaying a plurality of images to a viewer using an additive display device, each image of the plurality of images having a different color adjustment and at least two colors;
receiving input from the viewer selecting an image of the plurality of images based on a color perception of the selected image relative to other images of the plurality of images; and
displaying subsequent images according to the different color adjustment of the selected image.

2. The method of claim 1, wherein selecting the image based on the color perception includes a bias of the viewer.

3. The method of claim 1, wherein displaying the plurality of images includes simultaneously displaying at least two images of the plurality of images.

4. The method of claim 1, wherein selecting the image of the plurality of images is based on a perceived distinctiveness to the viewer of the at least two colors relative to one another within each image of the plurality of images.

5. The method of claim 4, wherein selecting the image of the plurality of images includes selecting the image of the plurality of images with a desired perceived distinctiveness of the at least two colors relative to one another within such image.

6. The method of claim 1, wherein displaying the plurality of images includes applying the color adjustment by at least one of optical modification, digital modification, and analog modification during creation of each image of the plurality of images from a corresponding representation of each image.

7. The method of claim 6, wherein applying the color adjustment during creation of each image from the corresponding representation of such image includes creating each image of the plurality of images from a corresponding digital image file for each image.

8. The method of claim 1, wherein displaying the plurality of images, each image of the plurality of images having at least two colors includes the at least two colors belonging to a different color family.

9. The method of claim 8, wherein displaying the plurality of images, each image of the plurality of images having at least two colors belonging to a different color family includes the different color family for each of the at least two colors being disposed between red and green.

10. The method of claim 8, wherein displaying the plurality of images, each image of the plurality of images having at least two colors includes the at least two colors being high lightness colors.

11. The method of claim 1, wherein displaying the plurality of images, each image of the plurality of images having at least two colors includes each of the at least two colors having a hue disposed in a region of overlapped cone response.

12. A method of color management in a display system based on perception, comprising:
displaying a plurality of images to a viewer using an additive display device, each image of the plurality of images having a different color adjustment and at least two colors;
receiving an input from the viewer selecting an image of the plurality of images based on a perceived distinctiveness to the viewer of the at least two colors of the selected image relative to one another; and
displaying subsequent images according to the different color adjustment of the selected image.

13. The method of claim 12, wherein displaying the plurality of images includes applying the different color adjustment at least one of digitally, optically, and in analog during creation of each image of the plurality of images from a corresponding representation of such image, and wherein the different color adjustment alters a color perception of at least one of the at least two colors by the viewer.

14. The method of claim 12, wherein displaying the plurality of images, each image of the plurality of images having at least two colors includes each of the at least two colors belonging to a different color family.

15. The method of claim 14, wherein displaying the plurality of images, each image of the plurality of images having at least two colors belonging to a different color family includes the different color family for each of the at least two colors being disposed between red and green.

16. The method of claim 14, wherein displaying the plurality of images, each image of the plurality of images having at least two colors belonging to a different color family includes each of the at least two colors having high lightness.

17. The method of claim 14, wherein displaying the plurality of images, each image of the plurality of images having at least two colors belonging to a different color family includes each of the at least two colors having a hue disposed in a region of overlapped cone response.

18. The method of claim 12, wherein displaying the plurality of images includes each image of the plurality of images having at least two colored regions, each colored region being defined by one of the at least two colors, and wherein the at least two colored regions define a shape, the perceived distinctiveness corresponding to an ability of the viewer to discern the shape.

19. A method of color management in a display system based on perception, comprising:
displaying a plurality of images using an additive display device in ambient light, each image of the plurality of images having a different color adjustment applied thereto and having a pair of colors, each color of the pair belonging to a different color family, a perceived distinctiveness of the colors within each pair being based on the ambient light and the different color adjustment;
selecting an image of the plurality of images for which the perceived distinctiveness is desired; and
displaying subsequent images according to the different color adjustment of the selected image.

20. The method of claim 19, wherein displaying the plurality of images includes creating each image of the plurality of images from a base image by applying a corresponding different color adjustment, the base image for each image of the plurality of images being at least substantially identical.

21. The method of claim 19, wherein displaying the plurality of images, each image of the plurality of images having a pair of colors, each color of the pair belonging to a different color family includes the different color family to which each color belongs being selected from reddish-orange, orange-pink, orange, yellowish-orange, yellow, greenish-yellow, yellow-green, and yellowish-green.

22. The method of claim 19, wherein displaying the plurality of images includes creating each image of the plurality of images from a corresponding digital image file, the color adjustment for at least a subset of the plurality of images being provided by one of
digital modification of the corresponding digital image file with a look-up table, and
digital white-point adjustment of the corresponding digital image file and optical modification during image creation from such digital image file using a band rejection filter.

23. The method of claim 19, wherein displaying the plurality of images includes each image of the plurality having a pair of colored regions, each colored region of the pair being defined by one of the pair of colors, and wherein the pair of colored regions defines a shape, the perceived distinctiveness corresponding to an ability of a viewer to discern the shape.

24. The method of claim 19, wherein displaying includes projecting the plurality of images and the subsequent images to a viewing surface that reflects such plurality and subsequent images to a viewer.

25. A method of color management in a display system based on perception, comprising:
displaying a plurality of images to a viewer using an additive display device, each image of the plurality of images having a pair of colors and a different color adjustment, the pair of colors corresponding to a pair of colored regions that define a shape, each color of the pair having high lightness and belonging to a different color family;
receiving an input from the viewer selecting an image of the plurality of images for which the shape is perceived by the viewer as most distinctive; and
displaying subsequent images according to the different color adjustment of the selected image.

26. The method of claim 25, wherein displaying the plurality of images includes the different color family to which each color belongs being disposed between red and green.

27. A display device for perception-based color management of displayed images, comprising:
a light engine configured to display images of a set and subsequent images to a viewer, each image of the set having at least two colors and a different color adjustment; and
a controller coupled to the light engine, the controller including digital image files corresponding to the images of the set and the subsequent images and having an input from the viewer selecting an image of the set based on a perceived distinctiveness of the at least two colors of such selected image relative to one another, the controller being configured to modify display of the subsequent images by the light engine according to the different color adjustment of the selected image.

28. The apparatus of claim 27, wherein the controller is configured to modify display of the subsequent images at least partially by signaling the light engine to provide an optical adjustment during creation of the subsequent images.

29. The apparatus of claim 27, wherein the controller is configured to modify display of the subsequent images at least partially by applying a digital modification to the digital image files corresponding to the subsequent images.

30. An apparatus for color management based on perception, comprising:
means for displaying a plurality of images, each image being displayed by combining light additively, each image of the plurality of images having a different color adjustment and at least two colors;
means for selecting an image of the plurality of images based on a perceived distinctiveness of the at least two colors of the selected image relative to one another; and
means for displaying subsequent images according to the different color adjustment of the selected image.

31. A program storage device readable by a processor, tangibly embodying a program of instructions executable by the processor to perform method steps for managing color in a display system based on perception, the method steps comprising:
creating instructions for display of a plurality of images by a light engine, each image of the plurality of images having a different color adjustment and at least two colors;
receiving input from the viewer selecting an image of the plurality of images based on a color perception of the selected image relative to other images of the plurality of images; and
creating instructions for display of subsequent images by the light engine according to the different color adjustment of the selected image.
